(19) United States
(12) Patent Application Publication
(10) Pub. No.: US 2010/0109267 A1
(43) Pub. Date: May 6, 2010

(54) SKI BIKE

(76) Inventor: Kevan Leycraft, Calgary (CA)

Correspondence Address: KLARQUIST SPARKMAN, LLP, 121 SW SALMON STREET, SUITE 1600, PORTLAND, OR, 97204, US

(21) Appl. No.: 12/611,011

(22) Filed: Nov. 2, 2009

Related U.S. Application Data
(60) Provisional application No. 61/110,023, filed on Oct. 31, 2008.

(51) Int. Cl. B62B 13/08

(52) U.S. Cl. 280/21.1

(57) ABSTRACT

A ski vehicle for traveling along a surface is disclosed. The ski vehicle includes a frame comprising a seat supporting member; a steering column rotatably coupled to the frame; a front ski, coupled to the steering column; a rear ski, coupled to the frame, the front and rear skis for supporting the ski vehicle on the surface; and a seat, coupled to the seat supporting member of the frame, for supporting a rider, the seat supporting member of the frame having sufficient length to allow a ski lift chair to slide thereunder. The ski vehicle has a minimum design rider weight, and the weight distribution of the vehicle is selected so that the vehicle is secured on the ski lift chair when the seat is slid over the chair and a rider of at least the design rider weight is sitting on the seat. The ski vehicle may also have a rear swing-arm having first, second and third corners, the first corner movably coupled to the frame and the second corner pivotably coupled to a pivot point on the frame such that the swing-arm pivots about the pivot point when the first corner is moved. The rear ski may be coupled to the rear swing-arm.

### CROSS REFERENCE TO RELATED APPLICATION

This application claims the benefit of U.S. Provisional Application No. 61/110,023, filed Oct. 31, 2008, the entirety of which is herein incorporated by reference.

### FIELD

The present disclosure relates to a gravity propelled, ski-supported vehicle. In particular, the present disclosure relates to such a vehicle that is adapted for use on snow.

### BACKGROUND

Ski biking is a sport that has existed for over one hundred and fifty years. Essentially, ski biking involves a rider mounting a vehicle, a ski bike, that typically has a frame; a steering mechanism and a seat, each of which is coupled to the frame; and front and rear skis, coupled to the frame, for riding over a snow covered slope. The rider is able to sit on the ski bike and enjoyably coast down the slope.

Ski bikes presently known in the art suffer from several problems, however. For example, due to their bulkiness, it can be difficult to transport ski bikes on chair lifts. While U.S. Pat. No. 6,783,134 to Geary discloses a ski bike that is adapted to be carried on a ski lift with a rider, Geary teaches a ski bike having a pivotable seat that is adjustable to a lowered position, the rider able to mount the ski lift with the ski bike when the seat is in the lowered position. Drawbacks of the design in Geary, however, include that a relatively complex mechanical configuration is required to implement the pivotable seat, and that the rider may find it cumbersome to consistently have to raise and lower the pivotable seat when boarding and disembarking from ski lifts.

FIG. 1 (PRIOR ART) depicts another exemplary ski bike 100 known in the art. The ski bike 100 has a seat 160 that is coupled to a frame 110 via shock absorbers 180 that extend from the underside of the seat 160. The ski bike 100 has not been adapted in any particular way to facilitate its transportation using, for example, a ski lift.

Consequently, there exists a need for a ski bike that improves on ski bikes known in the art.

### SUMMARY

According to one embodiment, there is provided a ski vehicle for traveling along a surface. The ski vehicle includes a frame having a seat supporting member; a steering column rotatably coupled to the frame; a front ski, coupled to the steering column; a rear ski, coupled to the frame, the front and rear skis for supporting the ski vehicle on the surface; and a seat, coupled to the seat supporting member of the frame, for supporting a rider, the seat supporting member of the frame having sufficient length to allow a ski lift chair to slide thereunder; wherein the ski vehicle has a minimum design rider weight, and the weight distribution of the vehicle is selected so that the vehicle is secured on the ski lift chair when the seat is slid over the chair and a rider of at least the design rider weight is sitting on the seat.

The ski vehicle can further include a frame support member coupled between the seat supporting member and a location on the frame nearer to the front of and bottom of the ski vehicle, the frame support member angled such that when the chair of the ski lift slides under the frame support member and the rider sits on the seat, the front ski is angled upwards relative to the horizontal.

According to another embodiment, there is provided a ski vehicle for travelling along a surface. The ski vehicle includes a frame; a steering column rotatably coupled to the frame; a front ski, coupled to the steering column; a seat, coupled to the frame, for supporting a rider; a rear swing-arm having first, second and third corners, the first corner movably coupled to the frame and the second corner pivotably coupled to a pivot point on the frame such that the swing-arm pivots about the pivot point when the first corner is moved; and a rear ski, coupled to the rear swing-arm, for supporting the ski vehicle on the surface.

The rear ski of the ski vehicle may be coupled to the third corner of the rear swing-arm. The rear swing-arm may be triangular. The first corner of the rear swing-arm may be coupled to a location on the frame between the pivot point and the steering column. The ski vehicle may also include a shock absorber coupled between the frame and the first corner of the rear swing-arm. The shock absorber may be slidably coupled to the frame. If slidably coupled to the frame, the shock absorber may be coupled to the frame using a multi-position bracket slidable along the frame, the multi-position bracket secured to the frame using a retractable pin that is insertable through both the multi-position bracket and a hole in the frame, thereby securing the shock absorber to the frame. The hole in the frame be one hole in a series of holes in the frame, the multi-position bracket slidable along the frame such that the retractable pin can be inserted through any hole in the series of holes.

### BRIEF DESCRIPTION OF THE DRAWINGS

FIG. 1 is a side elevation view of an exemplary ski bike of the prior art (PRIOR ART);

FIGS. 2 and 3 are perspective views of a ski bike according to a first embodiment;

FIG. 4 is a perspective view of a rider boarding a ski lift while sitting on the ski bike according to the first embodiment;

FIG. 5 is a detailed view of a release pin that aids in coupling a steering column of the ski bike to a frame of the ski bike, according to the first embodiment;

FIG. 6 is a detailed view of a multi-position bracket used to couple a shock absorber to the frame of the ski bike, according to the first embodiment;

FIG. 7 is a detailed view of a shock absorber located on the steering column of the ski bike, according to the first embodiment;

FIG. 8 is a detailed view of a rear ski mounting bracket that aids in coupling a rear ski to a rear swing-arm of the ski bike, according to the first embodiment;

FIG. 9 is a perspective view of an alternative steering column and front ski that can be coupled to the frame of the ski bike of the first embodiment;

FIG. 10 is a perspective view of a ski bike, incorporating the steering column depicted in FIG. 9, according to a second embodiment; and

FIG. 11 is a perspective view of a ski bike according to a third embodiment.

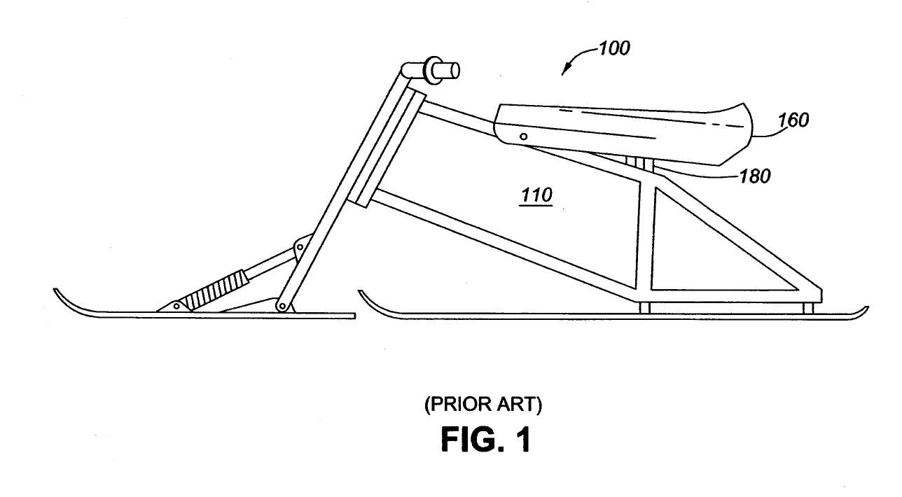

### DETAILED DESCRIPTION OF AN EXEMPLARY EMBODIMENT

Directional terms such as “top”, “bottom”, “front”, “back”, “vertical” and “horizontal” are used in the following description for the purpose of providing relative reference only, and are not intended to suggest any limitations on how any apparatus or components thereof are to be positioned during use or mounted in an assembly.

While the sport of ski biking has existed for over a hundred years, certain drawbacks in the designs of existing ski bikes have hindered the popularity of the sport. One problem with the design of existing ski bikes is that they are bulky, and consequently a rider can have difficulty transporting them up a ski hill. Because of their bulkiness, it can be very difficult and unsafe for a rider to board a ski lift with a ski bike. A rider who has to carry a ski bike in his or her lap, for example, may be unable to properly sit on a chair of the ski lift with the ski bike, and may be unable to close the safety bar of the ski lift. Many ski resorts have therefore prohibited the use of ski lifts to transport conventional ski bikes, which has severely hampered the growth of ski biking.

The ski bike described below addresses these issues in that it allows the rider to safely and easily board a ski lift with the ski bike.

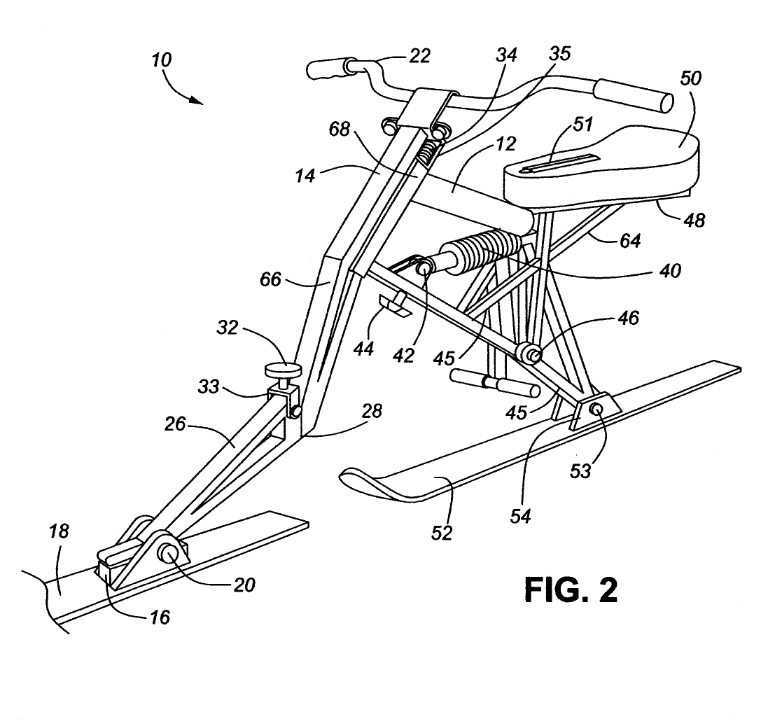

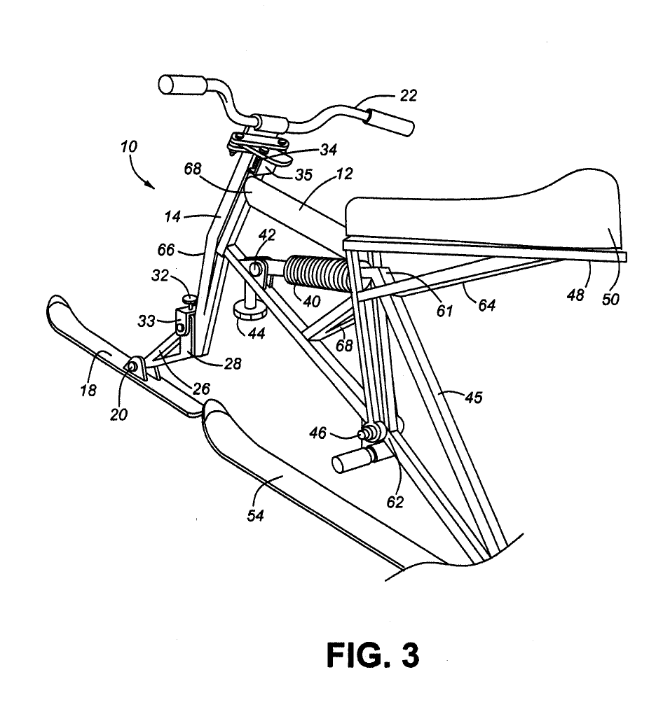

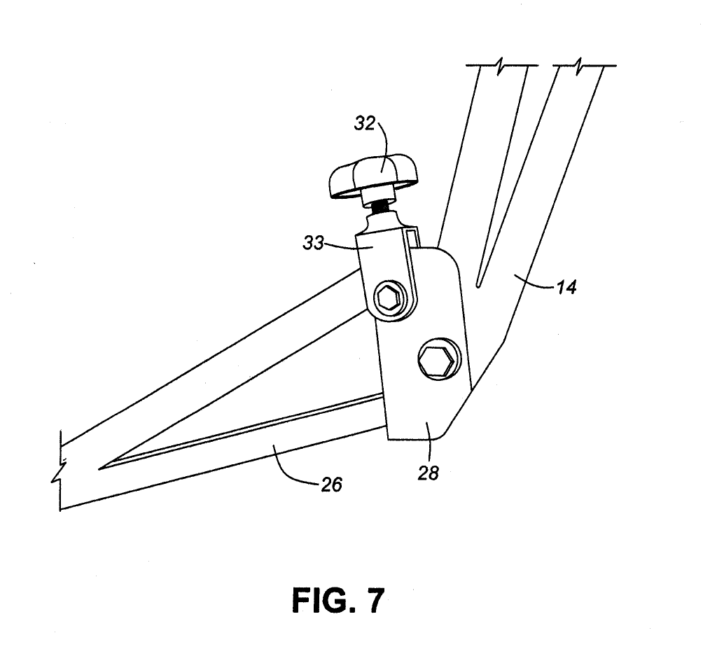

Referring now to FIGS. 2 and 3, there are depicted perspective views of a ski bike 10 according to a first embodiment. The ski bike 10 has a frame 12, which includes a parallelogram composed of a generally vertically extending front frame member, a pair of conjoined generally vertically extending rear frame members, and generally horizontally extending top and bottom frame members. A steering column 14 is rotatably coupled to the vertically extending front member of the frame 12. Handle bars 22 extend from either side of the top of the steering column 14 so as to allow the rider to steer the ski bike 10. A front suspension member 26 is at the bottom of the steering column 14 and is pivotably coupled thereto. The triangular front suspension member 26 depicted in FIGS. 2 and 3 is discussed in more detail with respect to FIG. 7, below. At the bottom of the front suspension member 26 is a front ski 18, which is coupled to the front suspension member 26 via a front ski bracket 20. The front ski bracket 20 is fixed to the front ski 18. Interposed between the front suspension member 26 and the front ski 18 is front elastomeric block 16 that acts to absorb forces subjected on the ski bike 10 during riding. A bolt, threaded through both the front ski bracket 20 and the front suspension member 26 can be used to secure the front ski 18 to the front suspension member 26. The bolt can be a grade 6 or harder bolt.

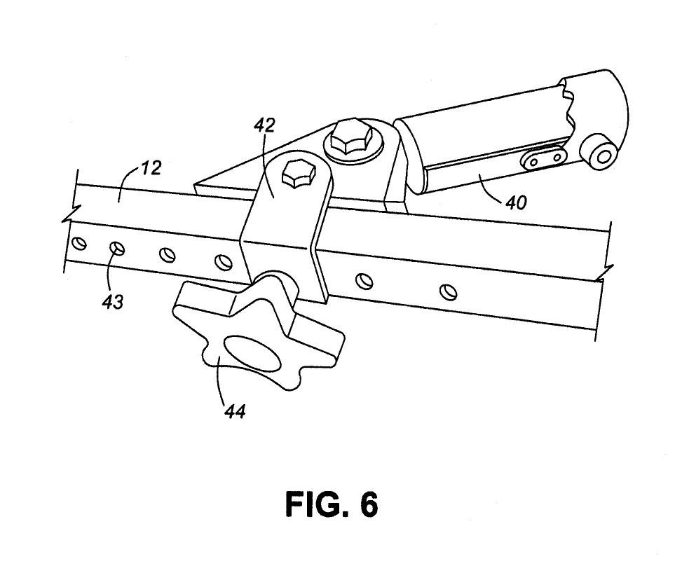

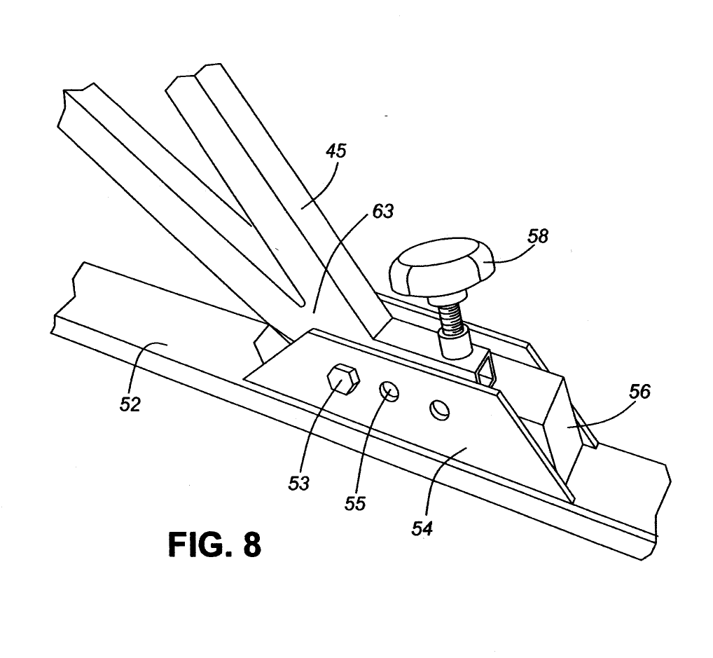

The frame 12 includes a seat supporting member 48 on which is supported a seat 50 for supporting the rider. Located within the front of the seat 50 is a zippered storage compartment 51 that can be used to store the rider's belongings. Also coupled to the frame 12 is a triangular rear swing-arm 45. The rear swing-arm 45 has three corners: first, second and third corners 61, 62 and 63, respectively. The second corner 62 is pivotably coupled to the frame 12 via a pivot point 46, which in this embodiment is a hardened bolt extending through a bracket extending upwardly from the bottom of the rear frame members. In the depicted embodiments, the bolt is journalled through the swing-arm 45. The rear swing-arm 45 can be constructed using hollow tubing formed from mild steel or aluminum, for example. The first corner 61 is movably coupled to the frame 12 via a central shock absorber 40. The central shock absorber 40 has a back end coupled to the rear swing-arm 45 and a front end coupled to the horizontally extending bottom frame member via an adjustable central bracket 42 that is slidably mounted to the bottom frame member. The central bracket 42 can be positioned at various locations along the frame 12 forward of (i.e.: nearer to the steering column 14) the pivot point 46. The manner in which the central bracket 42 is adjustable is discussed in more detail with respect to FIG. 6, below. Coupled to the third corner 63 via a rear ski bracket 54 is a rear ski 52, as discussed in greater detail with respect to FIG. 8, below.

Beneficially, the rider is able to adjust the height of the seat 50 by moving the central bracket 42 either towards the front (i.e.: towards the steering column 14) or the rear (i.e.: towards the seat 50) of the frame 12. As the central bracket 42 is moved nearer to the front of the frame 12, the rear swing-arm 45 pivots towards the frame 12 and the rear ski 52 is drawn towards the seat 50, thereby effectively lowering the height of the seat 50, which is beneficial for relatively short riders. In contrast, as the central bracket 42 is moved nearer to the rear of the frame 12, the rear swing-arm 45 pivots away from the frame 12 and the rear ski 52 is pushed away from the seat 50, thereby effectively raising the height of the seat 50, which is beneficial for relatively tall riders.

Together, the front suspension member 26, the rear swing-arm 45 and the central shock absorber 40 form part of the suspension system of the ski bike 10. When the swing-arm 45 rotates, force is translated radially about the pivot point 46. As the central bracket 42 is moved nearer to the front of the frame 12 and the seat 50 is lowered, a relatively high proportion of this radial force is transferred axially (as opposed to in shear) to the shock absorber 40, and the shock absorber 40 is able to absorb this axially transmitted force. In contrast, when the central bracket 42 is moved towards the rear of the frame 12 and the seat is raised, a relatively high proportion of this radial force is transferred in shear (as opposed to axially) to the shock absorber 40, and the shock absorber 40 is not able to absorb such force. Consequently, the suspension system of the ski bike 10 is relatively stiffer when the central bracket 42 is positioned near the rear of the frame 12 as opposed to when it is placed near the front of the frame 12.

Referring now to FIG. 6, there is depicted a detailed view of the interface between the central bracket 42 and the frame 12. Drilled into the frame 12 is a series of spaced holes 43. The central bracket 42 envelops the frame 12 and is slidable relative to it. On one side of the central bracket 42 the shock absorber 40 is securely fastened to the central bracket 42, and on an opposing side of the central bracket 42 is drilled a hole (not shown) through which a retractable pin (not shown) can be inserted. When the hole in the central bracket 42 is aligned with one of the holes 43 on the frame, and when the retractable pin is inserted through the aligned holes, the central bracket 42 is fixed relative to the frame 42. Attached to one end of the retractable pin is a rotatable knob 44. The retractable pin is threaded and can be screwed into and out of the frame 42 using the rotatable knob 44. The interior of the central bracket 42 is threaded such that it can mate with and securely retain the retractable pin. While this exemplary embodiment relies on threaded coupling to secure the retractable pin within the frame 12, in alternative embodiments (not depicted), the retractable pin may be coupled to a spring that, in its quiescent position, is able to push the retractable pin into and retain the retractable pin within the frame 12. In this alternative embodiment, the rider would be able to move the central bracket 42 by pulling the rotatable knob 44 away from the frame 12, which would bias the spring and retract the retractable pin from within the frame 12, thereby allowing the central bracket 42 to be slid along the frame 12.

Referring now to FIG. 7, there is depicted a detailed view of the front suspension member 26 that is utilized in the embodiment of the ski bike 10 illustrated in FIGS. 2 and 3. The front suspension member 26 is triangular and is formed from an elastomeric material, such as medium durometer petroleum rubber. The front suspension member 26 could also be formed using a material such as molded polyurethane having a durometer hardness of between 80 and 100. An elastomeric block 28 forms part of the front suspension member 26. When forces are transferred from the front ski 18 up through to the front suspension member 26, the elastomeric block 28 is compressed, thereby absorbing some of the forces and dampening the forces felt by the rider. Bolted to the elastomeric block 28 is a front hand screw bracket 33 through which a front hand screw 32 is threaded. By rotating the front hand screw 32, the front hand screw 32 can be positioned such that it impacts and compresses the elastomeric block 28, which accordingly reduces the ability of the elastomeric block 28 to absorb and dampen forces exerted on the front ski 18. The front hand screw 32 thereby effectively allows the rider to adjust the stiffness of the front suspension member 26.

Referring now to FIG. 8, there is depicted a detailed view of the rear ski 52 and the rear ski bracket 54. The rear ski bracket 54 is fixedly coupled to the rear ski 52 and is coupled to the rear swing-arm 45 via a bolt 53 that is threaded through one of three bolt holes 55 in the bracket 54 and through a hole in the rear swing-arm 45. The position of the rear ski bracket 54 and rear ski 52 relative to the swing-arm 45 varies depending on which of the three bolt holes 55 is used. Interposed between the swing-arm 45 and the rear ski bracket 54 is an elastomeric block 56. As with the front elastomeric block 16, the rear elastomeric block 56 acts to absorb forces subjected on the ski bike 10 during riding. A rear hand screw 58 can be screwed, in a direction generally perpendicular to the ground, which can compress the elastomeric block 56. Doing so reduces the ability of the elastomeric block 56 to absorb forces exerted on the rear ski 52, thereby resulting in a stiffer, or bumpier, ride for the rider. An aluminum plate (not shown) beneath the rear elastomeric block 56 distributes the force exerted by the hand screw 58 along the length of the block 56.

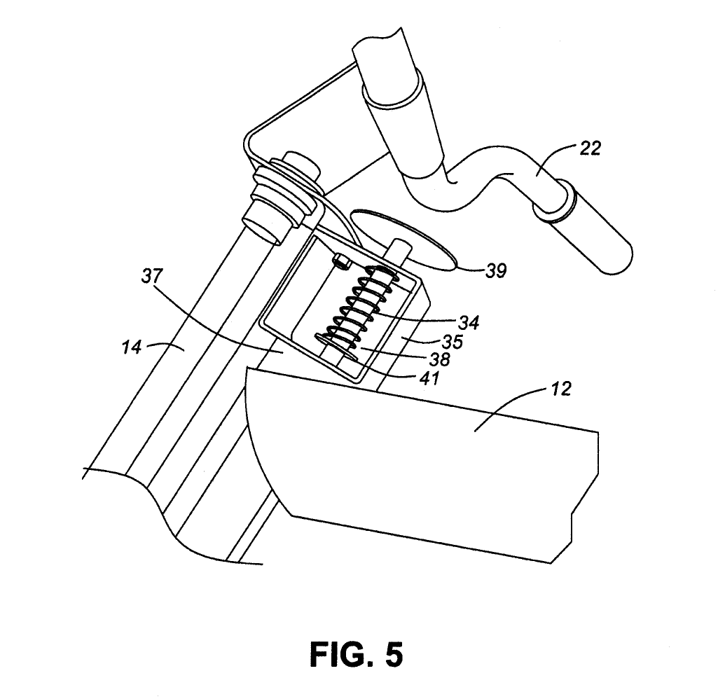

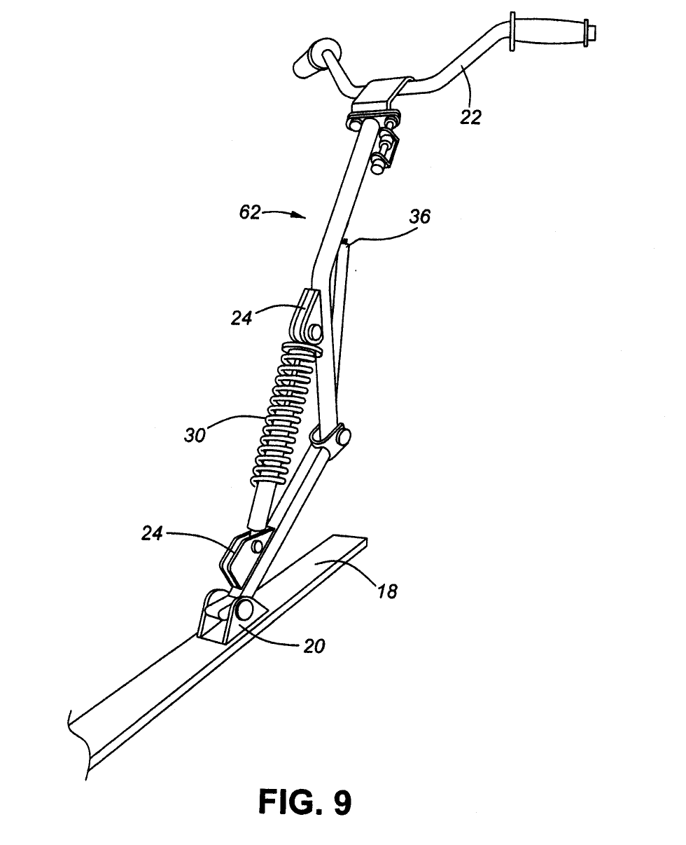

Referring now to FIG. 5, there is depicted a detailed view of a release pin 34 and release pin bracket 35 that can be used to attach and remove the steering column 14 to the frame 12. The release pin 34 and release pin bracket 35 are also visible in FIG. 9, which is a perspective view of an alternative steering column 62, especially designed for racing, that can be coupled to the frame 12 of the ski bike 10. The release pin 34 is threaded through the pin bracket 35 and has on one end of it a handle 39 that can be grasped by the rider. The release pin 34 also has surrounding it a spring 38 that biases the release pin 34 against the bracket 35 such that, by default, the end of the pin 34 without the handle 39 protrudes through and out of the pin bracket 35. The spring 38 is biased between an annular ring 41 welded to the pin 34 and the bracket.

Also visible in FIG. 9 on the alternative steering column 62 is a peg 36 (present on, but not illustrated in the figures that depict the steering column 14), collinear with the release pin 34. The peg 36, in conjunction with the release pin 34, assists in keeping the steering columns 14, 62 attached to the frame 12. Assuming the rider wants to attach one of the steering columns 14, 62 on to the ski bike 10, the rider can grasp and pull the handle 39 to retract the release pin 34 such that the end of the pin 34 without the handle 39 no longer protrudes from the pin bracket 35; align the peg 36 with and insert the peg 36 into a bottom portion 66 of the frame 12 that is adapted to receive the peg 36; while continuing to grasp the handle 39, align the release pin 34 with a top portion 68 of the frame 12 that is adapted to receive the release pin 34; and release the handle 39, thereby allowing the spring 38 to push the release pin 34 into the top portion of the frame 12. Optionally, inserted within the top and bottom portions of the frame 12 are reinforcing sleeve inserts 37 made of plastic or nylon, for example.

Similarly, to remove one of the steering columns 14, 62 from the frame 12, the rider can simply grasp and pull the handle 39 such that the release pin 34 is retracted into the pin bracket 35 and then remove the steering column 14, 62 from the frame 12.

Notably, when one of the steering columns 14, 62 is securely coupled to the frame 12, only the pin bracket 35, the peg 36 and the portion of the steering column 14, 62 immediately surrounding the peg 36 contact the frame 12.

Consequently, any forces transmitted to the steering column 14, 62 will not bias the spring 38, and there is no risk that the steering column 14, 62 will be decoupled from the frame 12 while riding the ski bike 10.

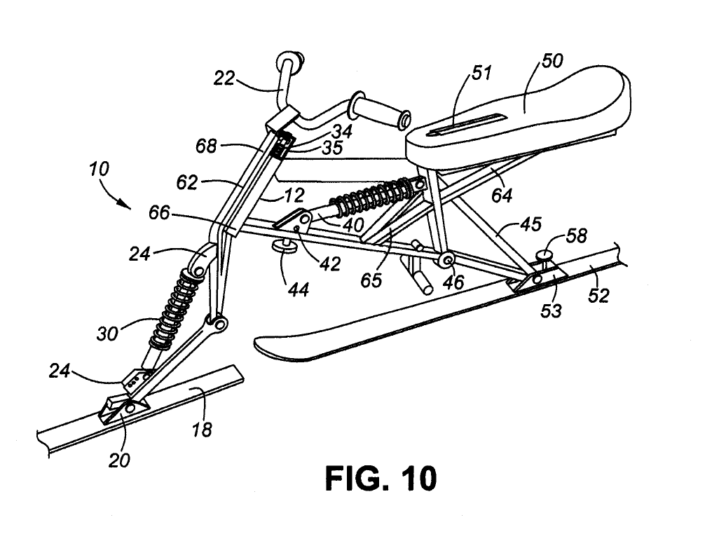

Referring now to FIG. 10, there is depicted a ski bike 10 utilizing the alternative steering column 62, according to a second embodiment. In lieu of a front suspension member 26 that uses the elastomeric block 28 as depicted in the first embodiment, the front suspension member 26 of this second embodiment utilizes a coil spring shock absorber 30 that is bolted to opposing suspension brackets 24. The coil spring shock absorber 30 is especially useful when the ski bike 10 is used in racing.

Additionally, when the ski bike 10 is being transported in, for example, a car or gondola, the steering column 14, 62 can be removed from the ski bike 10 so that the amount of space required to transport the ski bike 10 is reduced, thereby making ski bike 10 transportation easier.

Referring now to FIGS. 2, 3 and 10, the manner in which the ski bike 10 is adapted to allow it to be easily transported using a ski lift is illustrated. The seat 50 of the ski bike 10 is mounted on a seat supporting member 48, which forms part of the frame 12. Compared to conventional ski bikes 10, the seat supporting member 48 has been extended and angled such that it is at least long enough and properly positioned to easily allow a chair of a typical ski lift to slide thereunder. When the ski lift chair is under the seat supporting member 48, the rider may sit down on the seat 50, thereby securing the ski bike 10 to the ski lift chair using his or her own body weight. The ski lift can then transport both the rider and the ski bike 10 up a ski hill. As the ski bike 10 does not have to be awkwardly carried by the rider while seated in the ski lift chair, a ski lift safety bar may be safely closed over the rider even when the rider has boarded the ski lift with the ski bike 10. When the rider wishes to disembark from the ski lift, he or she may simply push off from the chair of the ski lift using the ground, thereby sliding the seat 50 off of the chair.

The ski bike 10 depicted in the figures also includes first and second strut pairs 64 and 65, respectively. The first strut pair 64 is coupled on one end to the seat supporting member 48 and on the other end to each of the vertically extending rear frame members. The first strut pair 64 transfers load borne by the seat supporting member 48 into the bulk of the frame 12, thereby aiding in the structural stability of the ski bike 10. When the rider sits on the seat 50 and when the chair of the ski lift is under the seat supporting member 48 and the first strut pair 64, parts of the first strut pair 64 will be pressed against the chair. This will angle the front ski 18 of the ski bike 10 upwards relative to the horizontal; i.e., relative to the position of the front ski 18 when the front ski 18 is resting on the ground prior to the rider boarding the ski lift. This advantageously provides some clearance between the ground and the front ski 18 when the ski bike 10 is being carried up the ski hill, and decreases the likelihood that the front ski 18 will impact or get caught on the ground or on any obstructions on the ground. The upwards angling provided by the first strut pair 64 is especially useful at the top of a ski hill when the rider is disembarking from the ski lift, as without the first strut pair 64 the front ski 18 would be prone to pointing and digging into the ground during disembarking, thus preventing smooth ski lift operations. Typically, angling the first strut pair 64 such that it makes an angle of about 10 or 20 degrees relative to the horizontal results in sufficient upwards angling of the front ski 18.

The second strut pair 65 is coupled on one end to the pair of vertically extending rear frame members and on another end to the horizontally extending bottom frame member. As with the first strut 64, the second strut 65 helps to distribute forces borne by the ski bike 10 throughout the frame 12, thereby aiding in the structural stability of the ski bike 10.

Typically, the seat 50 is no more than 4 inches high so as to ensure that the rider is not elevated too far off the ski lift chair. The length of the portion of the seat supporting member 48 is the depth of a typical ski lift chair, typically between 16 and 18 inches. This allows the entirety of the ski lift chair to fit under the seat 50, while still placing the rider within comfortable reach of the handle bars 22. A seat that is too long would allow the rider to sit such that the rider's center of gravity is too far behind the center of the rear ski 52, which could result in ski bike 10 instability.

The maximum weight of the ski bike 10 is typically about 12 kg, less than half of which is distributed near the front of the ski bike 10. Typically, one third of the ski bike weight is supported by the front ski 18 and two thirds of the ski bike weight is supported by the rear ski 52. The rider weight is positioned over the centre of the rear ski 52. This allows for a wide range of rider weight to be accommodated on the ski bike. For a ski bike 10 of about 12 kg, a rider weight of at least 50 kg is more than sufficient to secure the ski bike 10 to the ski lift chair. Specifically, the ski bike 10 has a minimum design rider weight, and when the weight of the rider is at least this minimum design rider weight, the weight of the rider prevents the ski bike 10 from pivoting about the edge of the ski lift chair and throwing the rider off of the chair. The weight of the rider results in torque being applied to the ski bike 10, which acts to secure the ski bike 10 to the ski lift chair. This torque is greater than and opposes the torque that results from the weight of the ski bike 10 that is distributed forward of the edge of the ski lift chair. It is in this fashion that the weight distribution of the vehicle is selected so that the vehicle is secured on the ski lift chair when the seat is slid over the chair and a rider of at least the design rider weight is sitting on the seat. The ski bike 10 can be manufactured in different weights, in which case the minimum design rider weight can be adjusted accordingly. If necessary, lead ballast can be added to the ski bike 10 to increase the ski bike weight to international racing standards of 20 kg.

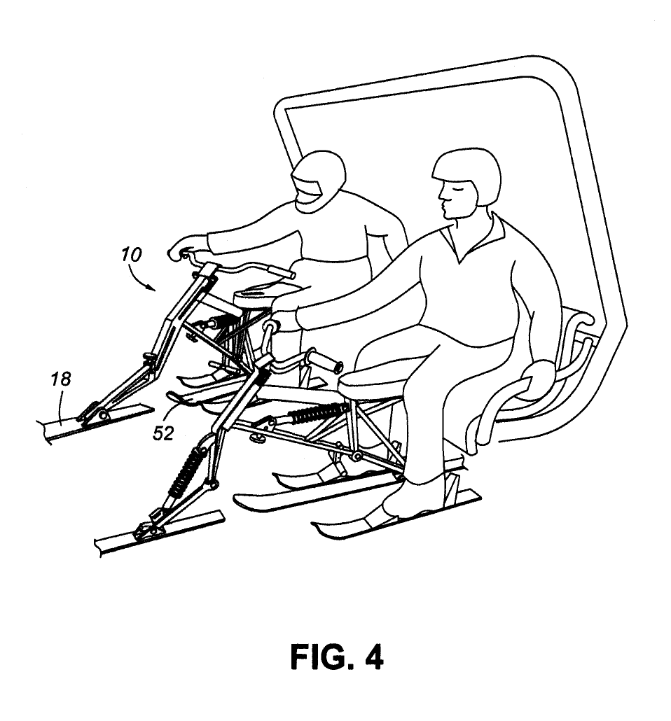

Referring now to FIG. 4, riders are depicted boarding a ski lift with the ski bike 10. As described above, the rider is able to be transported using the ski lift by allowing the chair of the ski lift to slide under the seat 50 of the ski bike 10 and by then simply sitting down. Also as described above, there is sufficient clearance between the front ski 18 and the ground to avoid having the front ski 18 contact the ground or any obstacles thereon. The ski bike 10 can be easily transported up the ski hill in a simple and safe fashion. Ample space exists for a safety bar to secure the riders in place.

One advantage of the present ski bike 10 is that in order to implement the suspension system of the ski bike 10, the ski bike 10 utilizes a combination of the rear swing-arm 45 coupled to the central shock absorber 40, which is coupled to the frame 12 at a location forward of the pivot point 46. In contrast to conventional ski bike designs, the design of the current ski bike 10 does not require a shock absorber to be placed directly under the seat 50. By utilizing the central shock absorber 40, which is located forward of the seat 50, space is created for the chair of a ski lift to slide under the seat 50, thereby facilitating easy transport of the ski bike 10 on the ski lift.

### Alternative Embodiment

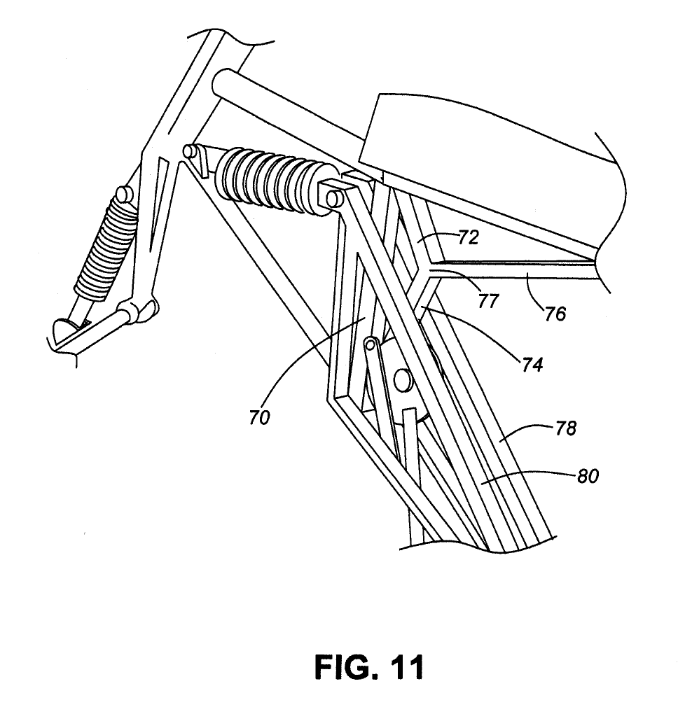

Referring now to FIG. 11, there is depicted an alternative embodiment in which the pair of conjoined generally vertically extending rear frame members is replaced with a single generally vertically extending rear frame member 70. Additionally, the first and second strut pairs 64, 65 are replaced with first, second and third single struts 72, 74, 76, respectively. The struts 72, 74, 76 are joined together at a common connection point 77. Third strut 76 extends from the connection point 77 and is joined to the underside of the seat supporting member 48, while first and second struts 72, 74 extend from the connection point 77 and are joined to the top and bottom of the generally vertically extending rear frame member 70. Furthermore, instead of being formed from a single triangular member, the rear swing-arm 45 is formed from a pair of conjoined triangular members 78, 80 that are joined together, with each triangular member placed on either side of the frame 12. Instead of having the swing-arm 45 sandwiched by the frame 12, as described with respect to the first and second embodiments above, in this alternative embodiment the the frame 12 is sandwiched by the swing-arm 45.

While illustrative embodiments of the invention have been described, it will be appreciated that various changes can be made therein without departing from the scope and spirit of the invention, as defined in the claims.

What is claimed is:

1. A ski vehicle for traveling along a surface, comprising:
(a) a frame comprising a seat supporting member;
(b) a steering column rotatably coupled to the frame;
(c) a front ski, coupled to the steering column;
(d) a rear ski, coupled to the frame, the front and rear skis for supporting the ski vehicle on the surface; and
(e) a seat, coupled to the seat supporting member of the frame, for supporting a rider, the seat supporting member of the frame having sufficient length to allow a ski lift chair to slide thereunder;
wherein the ski vehicle has a minimum design rider weight, and the weight distribution of the vehicle is selected so that the vehicle is secured on the ski lift chair when the seat is slid over the chair and a rider of at least the design rider weight is sitting on the seat.

2. A ski vehicle as claimed in claim 1 further comprising a frame support member coupled between the seat supporting member and a location on the frame nearer to the front of and bottom of the ski vehicle, the frame support member angled such that when the chair of the ski lift slides under the frame support member and the rider sits on the seat, the front ski is angled upwards relative to the horizontal.

3. A ski vehicle for travelling along a surface, comprising:
(a) a frame;
(b) a steering column rotatably coupled to the frame;
(c) a front ski, coupled to the steering column;
(d) a seat, coupled to the frame, for supporting a rider;
(e) a rear swing-arm having first, second and third corners, the first corner movably coupled to the frame and the second corner pivotably coupled to a pivot point on the frame such that the swing-arm pivots about the pivot point when the first corner is moved; and
(f) a rear ski, coupled to the rear swing-arm, for supporting the ski vehicle on the surface.

4. A ski vehicle as claimed in claim 3 wherein the rear ski is coupled to the third corner of the rear swing-arm.

5. A ski vehicle as claimed in claim 4 wherein the rear swing-arm is triangular.

6. A ski vehicle as claimed in claim 5 wherein the first corner of the rear swing-arm is coupled to a location on the frame between the pivot point and the steering column.

7. A ski vehicle as claimed in claim 6 further comprising a shock absorber coupled between the frame and the first corner of the rear swing-arm.

8. A ski vehicle as claimed in claim 7 wherein the shock absorber is slidably coupled to the frame.

9. A ski vehicle as claimed in claim 8 wherein the shock absorber is slidably coupled to the frame using a multi-position bracket slidable along the frame, the multi-position bracket secured to the frame using a retractable pin that is insertable through both the multi-position bracket and a hole in the frame, thereby securing the shock absorber to the frame.

10. A ski vehicle as claimed in claim 9 wherein the hole in the frame comprises one hole in a series of holes in the frame, the multi-position bracket slidable along the frame such that the retractable pin can be inserted through any hole in the series of holes.
